(19) United States
(12) Patent Application Publication
(10) Pub. No.: US 2017/0351825 A1
(43) Pub. Date: Dec. 7, 2017

(54) METHOD AND APPARATUS FOR QUANTIFYING AND MONITORING THE FRAILTY OF A SUBJECT

(71) Applicant: KONINKLIJKE PHILIPS N.V., ElNDHOVEN (NL)

(72) Inventors: GIJS GELEIJNSE, GELDROP (NL); NAGARAJU BUSSA, HYDERABAD (IN); RAJENDRA SINGH SISODIA, BHOPAL (M.P.) (IN); VIKRAM BASAWARAJ PATIL OKALY, BANGALORE (IN)

(21) Appl. No.: 15/523,891

(22) PCT Filed: Nov. 10, 2015
(86) PCT No.: PCT/EP2015/076270

§ 371 Date: May 2, 2017

(30) Foreign Application Priority Data
Nov. 12, 2014 (IN) 5690/CHE/2014
Nov. 20, 2014 (EP) 14194085.8

(51) Int. Cl. G06F 19/00

(52) U.S. Cl. CPC G06F 19/3406; G06F 19/3431; G06F 19/363; G06F 19/3481

(57) ABSTRACT

A computer-implemented method of assessing the frailty of a subject, the method comprising: receiving a plurality of force measurements obtained by a measurement apparatus configured to determine the weight of a subject standing on a user support surface of the measurement apparatus by measuring a force experienced by the user support surface; wherein the force measurements are obtained at regular time intervals over a measurement period during which the subject steps onto and subsequently stands on the user support surface; calculating a frailty index indicative of a degree of frailty of the subject using the received force measurements; wherein calculating a frailty index comprises: (a) identifying a first section of the received force measurements within the measurement period as a mounting period, wherein the mounting period extends between a first time at which the subject first contacts the user support surface, and a second time at which entire weight of the subject becomes supported by the user support surface; (b) identifying a second section of the received force measurements within the measurement period as a standing period, wherein the standing period commences after the end of the mounting period; (c) determining one or more parameters relating to the mounting period; (d) determining one or more parameters relating to the standing period; (e) comparing each of the determined parameters to a corresponding predefined threshold; and (f) calculating the frailty index based on the comparison; and generating an output signal indicative of the frailty index.

### TECHNICAL FIELD OF THE INVENTION

The invention relates to a method and apparatus for quantifying and monitoring the frailty of a subject, and in particular relates to a method and apparatus for quantifying and monitoring the frailty of a subject using a weight scale.

### BACKGROUND TO THE INVENTION

The functional status of elderly subjects is not only affected by their morbidities, but also by a general condition called frailty. Frailty is characterized by risk of falling, reduced mobility and functional status (e.g. ability to wash, cook, go to the toilet, etc.), and ultimately, increased mortality and hospitalization risk. Frailty can develop with aging, with the onset of diseases, or after a long period of sickness, and/or as a result of losing muscle strength after prolonged bed rest. Frailty can also be seen in subjects with nutritional disorders and central nervous system diseases like Parkinson's disease. Frailty has implications for a subject's care needs, beyond those resulting from their underlying medical condition and their psycho-social status. For example, if a subject cannot reach their toilet due to their frailty, extensive home care services or a transfer to a skilled nursing facility may be appropriate.

While it is fairly easy to recognize a frail, elderly person, it is hard to monitor frailty from a distance, or track the progression of frailty over time. According to one “standard” definition of frailty, a subject is considered to be frail if at least 3 of the following criteria are true (Fried et. al., “Frailty in Older Adults: Evidence for a Phenotype”, Journal of Gerontology, 2001):

Unintentional weight loss of>10 pounds in last year.

Self-reported exhaustion (based on a 2 question questionnaire).

Physical activity level over a week.

Time to walk 15 feet.

Hand grip strength.

This method has severe limitations in practice as it requires several tests to be done with the patient, and depends on self-reporting. Therefore, it is currently routinely applied only in clinical settings. Also, it does not enable progression of frailty to be reliably tracked, as the instrument is too coarse-grained and it is very difficult to maintain personalized reports.

An alternative method has been proposed by J Fontecha et. al. at the University of Castilla-La Mancha, which uses accelerometer enabled smartphones. Using these devices, the movements of a subject are tracked during a number of controlled tests, such as a “get-up-and-go” test. However, this method has not yet been clinically validated, and it has the drawback that it requires the subject to introduce at least one additional test, as well as additional equipment (or applications), into their daily routine.

A method for estimating an individual's Fried frailty index based on data collected by one or more body-worn inertial sensors has been disclosed in US 2013/110475. Said method makes use of the inertial sensor data may be collected during a walking trial, such as a timed-up-and-go (TUG) test. Parameters quantified by the inertial sensor data may be used as input parameters in a model (e.g., a regression model) that assesses the individual's frailty.

A reliable means of measuring and tracking the progression of frailty, particularly a means which is suitable for remote monitoring, would be a valuable tool to improve outcomes and quality of care for elderly subjects. There is therefore a need for an improved method and apparatus that can quantify the frailty of a subject and detect changes in frailty over time. Such a method and apparatus could be used in a home or hospital-based monitoring system to detect the presence and progression of frailty, and as a basis for subsequent decisions about the subject's care plan.

### SUMMARY OF THE INVENTION

According to a first aspect of the invention, there is provided a computer-implemented method of assessing the frailty of a subject, the method comprising:

receiving a plurality of force measurements obtained by a measurement apparatus configured to determine the weight of a subject standing on a user support surface of the measurement apparatus by measuring a force experienced by the user support surface; wherein the force measurements are obtained at regular time intervals over a measurement period during which the subject steps onto and subsequently stands on the user support surface;

calculating a frailty index indicative of a degree of frailty of the subject using the received force measurements;

wherein calculating a frailty index comprises:
(a) identifying a first section of the received force measurements within the measurement period as a mounting period, wherein the mounting period extends between a first time at which the subject first contacts the user support surface, and a second time at which entire weight of the subject becomes supported by the user support surface;
(b) identifying a second section of the received force measurements within the measurement period as a standing period, wherein the standing period commences after the end of the mounting period;
(c) determining one or more parameters relating to the mounting period;
(d) determining one or more parameters relating to the standing period;
(e) comparing each of the determined parameters to a corresponding predefined threshold; and
(f) calculating the frailty index based on the comparison; and generating an output signal indicative of the frailty index.

Thus, embodiments of the claimed invention advantageously enable parameters derived from measurements acquired using a conventional weight scale to be combined into a numerical frailty index. The output signal (for instance the value of the frailty index) can be tracked over time, which provides the care giver with a better, broader and also more objective picture of the health condition of the subject. Such quantified frailty progression information can advantageously be used to steer a physical activity or rehabilitation program, to select appropriate health and/or social care services for a subject, to identify health deterioration at an early stage and intervene accordingly, etc. Furthermore, as the weight scale is common device which is already used by many patients for remote monitoring purposes, embodiments of the claimed invention are suitable for use in a subject's home and can easily be integrated into their regular routine, making them convenient and unobtrusive.

In some preferred embodiments of the invention the one or more parameters relating to the mounting period are selected from:

duration of the mounting period; and

change in duration of the mounting period from a historical duration value.

In some such embodiments, the method further comprises extracting an amplitude-versus-time signal from the received force measurements. It will be appreciated that a more frail subject will typically find it more difficult to climb onto a weight scale, and therefore will take longer to do so. Determining the duration of the mounting period and/or the change in the duration of the mounting period from a historical duration value can therefore provide an important insight into the frailty of a subject.

In some such embodiments the standing period comprises a balancing section during which the amplitude variation of the extracted signal exceeds a predefined stability range, and a stable section during which the amplitude variation of the extracted signal is within the predefined stability range. Advantageously, defining a balancing section allows it to be determined how long it took the subject to become stable. It will be appreciated that a more frail subject will typically find it more difficult to balance on a weight scale, and therefore will take longer to become stable. Determining the duration of a balancing period and/or the change in the duration of a balancing period from a historical duration value can therefore provide an important insight into the frailty of a subject.

In some preferred embodiments of the invention the one or more parameters relating to the standing period are selected from a set of parameters comprising:

duration of the balancing period;

change in duration of the balancing period from a historical duration value;

actual weight of the subject; and

change in actual weight from a historical weight value.

It will be appreciated that increasing frailty is often associated with weight loss. Determining the actual weight of a subject and/or the change in actual weight from a historical weight value can therefore provide an important insight into the frailty of a subject.

In some such embodiments the received plurality of measurements comprises measurements obtained by a plurality of spatially separated force sensors. In such embodiments the set of parameters from which the one or more parameters relating to the standing period are selected from additionally includes:

pressure distribution across the plurality of force sensors.

In some embodiments the method further comprises receiving height information about the subject, and calculating the frailty index additionally comprises determining one or more parameters relating to a body mass index, BMI, of the subject. In some such embodiments the one or more parameters relating to a BMI of the subject comprise actual BMI and/or change in actual BMI from a historical BMI value. It will be appreciated that increasing frailty is often associated with loss of muscle, but that this may not be reflected by a subject's actual weight (for example if they have simultaneously gained fat). Equally, it is difficult to assess whether a subject's weight is too low (which can indicate frailty) without knowing their height. Determining the BMI of a subject and/or the change in BMI from a historical BMI value can therefore be useful in assessing the frailty of a subject.

In some embodiments the method further comprises receiving one or more grip strength measurements, and calculating the frailty index additionally comprises determining one or more parameters relating to the grip strength of the subject. In some such embodiments the one or more parameters relating to the grip strength of the subject comprises an actual grip strength and/or change in actual grip strength from a historical grip strength value. It will be appreciated that decreasing grip strength is often associated with increased frailty. Determining the actual grip strength of a subject and/or the change in actual grip strength from a historical grip strength value can therefore provide an important insight into the frailty of a subject.

In some embodiments calculating the frailty index additionally comprises determining one or more correlation parameters. In such embodiments a correlation parameter indicates a degree of correlation between two or more of the determined parameters relating to the mounting period and/or the determined parameters relating to the standing period. Some parameters may individually change or be at a concerning level for reasons other than frailty (for instance grip strength may reduce due to a hand injury, but a hand injury would be unlikely to also cause weight loss). Thus considering two or more parameters in combination (by assessing correlations) can provide a more reliable indication of frailty.

In some embodiments comparing each of the determined parameters to a corresponding predefined threshold comprises:
a) determining a frailty score for each one of the determined parameters by:
   i) relating a determination result obtained in respect of the given determined parameter to a corresponding degree of frailty using a parameter-specific relation between the given determined parameter and degree of frailty, wherein the parameter-specific relation is generated based on historical frailty data for a group of patients; and
   ii) calculating the frailty score based on the corresponding degree of frailty; and
b) comparing each determined frailty score to the corresponding predefined threshold.

In such embodiments the value of each of the corresponding predefined thresholds is set to correspond to a particular frailty score.

In some such embodiments the method further comprises determining the subject to be not frail if none of the determined parameters exceeds the corresponding predefined threshold; and determining the subject to be frail if one or more of the determined parameters exceeds the corresponding predefined threshold. In some embodiments which involve determining a frailty score for each determined parameter, calculating the frailty index comprises:

determining the frailty index to be a highest frailty score; or

determining the frailty index to be the average of two or more of the highest frailty scores.

In some embodiments the method further comprises:

storing at least each most recent historical determined parameter for the subject;

calculating, for each of the one or more parameters relating to the mounting period and the one or more parameters relating to the standing period, a difference between the current determined parameter and the most recent historical determined parameter; and

for each of the one or more parameters relating to the mounting period and the one or more parameters relating to the standing period, if the difference exceeds a predefined threshold, discarding the current determined parameter.

In some embodiments the method further comprises storing historical values of the frailty index for the subject and comparing the current frailty index value with the historical values to detect trends in the frailty index.

There is also provided, according to a second aspect of the invention, a computer program product, comprising computer readable code, the computer readable code being configured such that, on execution by a suitable computer or processor, the computer or processor performs the method of the first aspect, including without limitation any steps and sub-steps disclosed herein.

There is also provided, according to a third aspect, apparatus for use in assessing the frailty of a subject, comprising a processing unit (for instance a control unit) configured to perform the method of the first aspect. The skilled in the art will foresee that any step and sub-step of said method can be achieved by an apparatus according to the present invention. Said apparatus shares the same advantages as mentioned hereinabove for the method according to the present invention.

There is also provided, according to a fourth aspect, a system for use in assessing the frailty of a subject, comprising:

a measurement unit coupled to a user support surface configured to be stepped onto and subsequently stood on by the subject, wherein the measurement unit is configured to measure a force applied to the user support surface at regular time intervals over a measurement period during which the subject steps onto and subsequently stands on the user support surface; and

an apparatus according to the third aspect.

These and other aspects of the invention are apparent from and will be elucidated with reference to the embodiments described hereinafter.

It will be appreciated by those skilled in the art that two or more of the above-mentioned options, implementations, and/or aspects of the invention may be combined in any way deemed useful.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is an illustration of an apparatus for measuring the frailty of a subject according to an embodiment;

FIG. 2 is a flow chart illustrating a method of assessing the frailty of a subject according to a general embodiment of the invention; and

FIG. 3 is a graph of force against time for an example plurality of received force measurements.

### DETAILED DESCRIPTION OF THE PREFERRED EMBODIMENTS

Certain embodiments will now be described in greater detail with reference to the accompanying drawings. In the following description, like drawing reference numerals are used for like elements, even in different drawings. The matters defined in the description, such as detailed construction and elements, are provided to assist in a comprehensive understanding of the exemplary embodiments. Also, well known functions or constructions are not described in detail since they would obscure the embodiments with unnecessary detail. Moreover, expressions such as “at least one of”, when preceding a list of elements, modify the entire list of elements and do not modify the individual elements of the list.

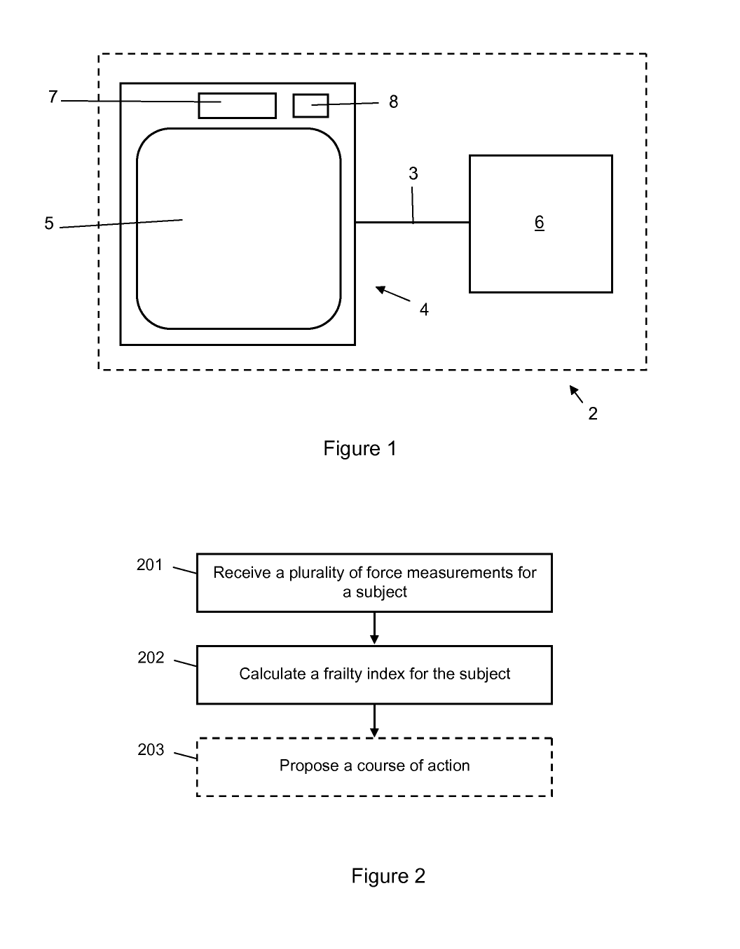

FIG. 1 shows a system for use in measuring the frailty of a subject (patient) that can implement the method according to the invention. The system 2 comprises a weight scale 4 that measures the downwards force (“weight”) on the scale over time, and a control unit 6 that is in communication with the weight scale 4 via a communications link 3, such that it can receive measurements from the weight scale. In some embodiments the control unit 6 can also send control signals to the weight scale 4.

The weight scale 4 has a user support surface 5 upon which a subject stands to obtain a measurement of their weight. The weight scale 4 measures a force experienced by the user support surface 5, for example by means of one or more force sensors arranged under the user support surface. In preferred embodiments the weight scale is configured to obtain force measurements at regular time intervals. In preferred embodiments the weight scale is configured to obtain at least 10 force measurements per second. In some such embodiments the weight scale is configured to obtain at least 20 force measurements per second. The obtained force measurements are stored in a memory, e.g. of the control unit 6. Alternatively or additionally, in some embodiments the obtained force measurements are transmitted in real-time to an external device. In some embodiments the weight scale 4 has a display 7 configured to display information, e.g. a measured weight value, to the subject. In some embodiments the weight scale 4 has a user input device 8, e.g. a keypad, which enables the subject to input data to the weight scale 4.

The control unit 6 is configured to calculate a frailty index indicative of a degree of frailty of the subject using the received force measurements. In some embodiments the control unit 6 comprises a plurality of modules. In such embodiments the modules include one or more of:

a module configured to compute the time the patient took to mount the weight scale;

a module configured to compute the amplitude of the force measurements;

a module configured to determine the actual weight of the patient;

an interactive module via which the subject may enter data, e.g. height data;

a module configured to compute a body mass index (BMI) of the subject;

a module configured to compute a frailty index based on the output of one or more other modules of the control unit;

a module configured to propose a course of action on the basis of a computed frailty index.

In some embodiments the weight scale 4 and the control unit 6 are provided in a single device. In other embodiments the control unit 6 is separate from the weight scale 4. In such embodiments the weight scale 4 and the control unit 6 each include a communications interface to enable a communications link to be established between the weight scale 4 and the control unit 6. In such embodiments the weight scale 4 is configured to transmit data, e.g. force measurements, to the control unit 6.

In preferred embodiments the control unit 6 is configured to calculate a frailty index by performing the method shown in FIG. 2, which will be explained hereunder.

In another embodiment, the control unit 6 may be comprised in an apparatus, for instance a mobile phone, a tablet, a computer, a network, a cloud or any other medium that could be foreseen by the skilled in the art to satisfy the criteria herein. Said apparatus being configured to receive force measurements (or any signal from which said force measurements may be derived) from a measurement apparatus 4 (such as a weight scale) by wireless communication (for instance via Bluetooth, Wi-Fi, ZigBee, NFC, the Internet) or by wire communication (for instance via a USB cable, a micro-USB cable, or any cable suitable to transfer data). Said apparatus further comprises a control unit 6 arranged configured to calculate a frailty index by performing the method depicted in FIG. 2.

As an example of the embodiment described in the previous paragraph, the apparatus may comprise a so-called app (application program) designed to perform a group of coordinated functions, tasks, or activities for the benefit of the user, said function corresponding to the method depicted in FIG. 2.

FIG. 2 shows a method of assessing the frailty of a subject. In step 201 a plurality of force measurements are received, e.g. by the control unit 6. Each force measurement in the received plurality of force measurements is associated with a time at which the measurement was acquired (e.g. each measurement is time-stamped by the weight scale when it is acquired). In preferred embodiments the force measurements are acquired at regular time intervals, such that the received plurality of measurements covers a time period (the “measurement period”) between the time associated with the earliest obtained measurement and the time associated with the latest obtained measurement. In a preferred embodiment 20 measurements are acquired per second, such that that the time interval between consecutive measurements in the plurality of received measurements is 50 ms. It will be appreciated, however, that other measurement frequencies may be used. In some embodiments at least some of the plurality of force measurements are received at the same time (e.g. if the weight scale 4 is configured to store the measurements before transmitting them to the control unit 6). In some such embodiments all of the force measurements are received at the same time, after the acquisition of the final force measurement. In other embodiments each measurement in the plurality is received separately (e.g. if the weight scale 4 is configured to transmit force measurements to the control unit 6 in real time).

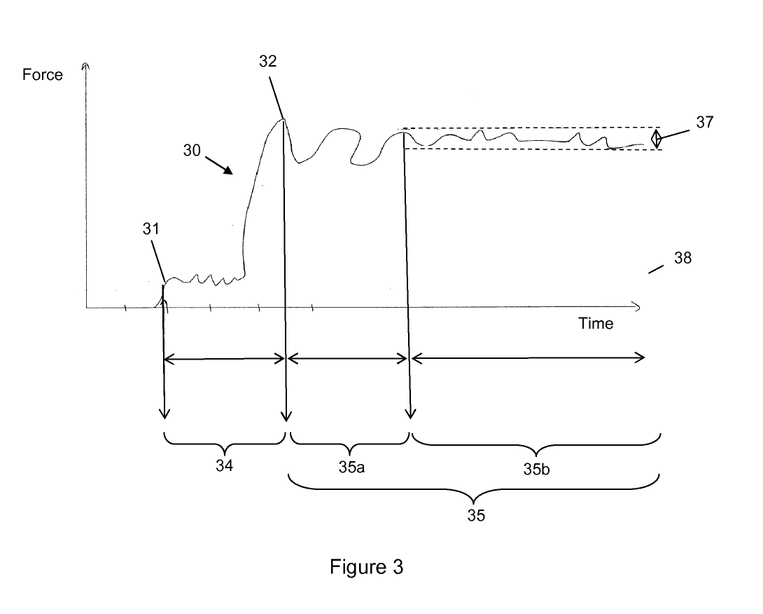

In step 202 a frailty index indicative of a degree of frailty of the subject is calculated (e.g. by the control unit) using the received force measurements. FIG. 3 shows a graph of force against time for an example plurality of received force measurements. Parameters extracted from the resulting curve 30 are used in the calculation of the frailty index. In a first stage, a mounting period 34 (corresponding to the time between when the patient first contacts the user support surface 5 of the weight scale 4, e.g. with their first foot, and when their full weight becomes supported by the support surface of the weight scale, e.g. when their second foot is fully on the user support surface) is identified. It will be appreciated that when the entire (full, whole, total) weight of the subject is supported by the user support surface, none of the weight of the subject is supported by a surface other than the user support surface (e.g. the ground, a handrail, etc.). It will also be appreciated that the full weight of the subject may not be supported by the user support surface, even though none of the weight of the subject is supported by a surface other than the user support surface. This will be the case, for example, if the patient jumps up and down or even merely flexes their knees whilst standing on the user support surface.

Various methods for determining when such entire weight of the subject has become supported by the user support surface will be known to the skilled person. For example, in some embodiments the moment at which the full weight of the subject becomes supported by the user support surface is identified in relation to the maximum force measured during the measurement period. In some such embodiments the mounting period is defined as a section of the measurement period between the first force measurement 31 to have a value greater than a predefined threshold 38 and the first (or second, etc.) force measurement 32 to have a value which is equal or nearly equal (where, for example, a threshold may be provided to determine whether a force value is “nearly equal”) to the maximum force measured during the measurement period. In some embodiments the predefined threshold 38 is zero (such that the earliest received measurement having a positive value marks the start of the mounting period). In other embodiments (such as that illustrated by FIG. 3) the predefined threshold 38 has a positive value. In preferred such embodiments, the threshold value is selected such that force measurements which do not result from the subject stepping onto the user support platform 5 of the weight scale 4 are excluded from the mounting period 34 (e.g. force measurements resulting from the subject moving the weight scale, or knocking into it before they start to mount). In alternative embodiments the weight scale may include one or more additional sensors for determining when the full weight of the subject becomes supported by the user support surface (e.g. contact sensors arranged to detect when both feet of the subject are in contact with the user support surface).

In some embodiments the weight scale 4 is configured to begin acquiring force measurements as soon as it detects a force being applied to the user support surface 5, in which case the first force measurement of the mounting period 34 will generally be the earliest received force measurement. In alternative embodiments the weight scale 4 is configured to begin acquiring force measurements in response to a specific trigger event (for example the user pressing a “start” button of the weight scale). In such alternative embodiments there will generally be a delay between the time of the trigger event and the time at which the subject begins to mount the weight scale 4. Therefore, a set of the received plurality of force measurements (i.e. those measurements obtained during the delay) will have a zero value and will not exceed the threshold 38. In such cases it will be appreciated that the first force measurement of the mounting period 34 (i.e. the earliest received force measurement to exceed the threshold) will not be the earliest received force measurement. As stated above, the end of the mounting period is marked by the first (or second, etc.) force measurement 32 to have a value which is equal or nearly equal to the maximum force measured during the measurement period (since this indicates the point from which the full weight of the subject is being supported by the weight scale, assuming that the subject successfully mounts the weight scales during the measurement period).

In a second stage, a standing period 35 (corresponding to the time during the measurement period for which the subject was standing fully on the user support platform 5 of the weight scale 4) is identified. The standing period 35 is defined as a section of the measurement period which commences after the end of the mounting period. In preferred embodiments the standing period 35 has a predefined length. In one such embodiment the length of the standing period is 10 s, although it will be appreciated that other lengths may be used. In some embodiments (such as the embodiment illustrated by FIG. 3) the standing period 35 commences immediately after the mounting period. In alternative embodiments, the standing period commences a predefined amount of time (or number of measurements) after the end of the mounting period. It can be seen from FIG. 3 that (assuming the subject successfully manages to stand stably on the weight scale) the standing period 35 comprises two sections: a balancing section 35a during which the amplitude variation of the force signal 30 exceeds a predefined range 37, and a stable section 35b during which the amplitude variation of the force signal 30 is within the predefined range 37. In preferred embodiments the length of the standing period 35 is selected to be sufficiently long to allow the majority of subjects to achieve stability within the standing period. It will be appreciated that the standing period need not extend to the end of the measurement period, for example if a given subject has stood on the weight scale for an unusually long time. Indeed, in preferred embodiments the length of the standing period 35 is selected to be short enough that the standing period 35 does not extend to the end of the measurement period in the majority of cases. In some situations the measurement period may end part-way through the standing period 35, for example if the subject dismounts from the weight scale 4 immediately after mounting. In such cases the data for the stability period (if there is any) is invalid, and so it will not be possible to determine at least some parameters relating to the standing period. In some embodiments if no valid data is available for at least part of the standing period the received measurements are discarded.

Parameters relating to the mounting period and to the standing period are then determined, as follows. Parameters which can be determined for the mounting period include:

duration of the mounting period 34 (which corresponds to the time elapsed between the subject placing their first foot on the weight scale and placing their second foot on the weight scale);

change in duration of the mounting period 34 from a historical duration value (e.g. the most recent previously determined duration of the mounting period).

Parameters which can be determined for the standing period include:

duration of the balancing period 35a (which corresponds to the time elapsed between the subject placing their second foot on the weight scale and achieving a stable stance);

change in duration of the balancing period 35a from a historical duration value (e.g. the most recent previously determined duration of the balancing period);

pressure distribution across the force sensors (where the weight scale 4 includes a plurality of spatially separated force sensors);

actual weight of the subject;

change in actual weight from a historical weight value (e.g. the most recent previously determined actual weight).

In preferred embodiments, all of the above parameters are determined. However, embodiments are possible in which only a subset of the above parameters are determined. For example, it is possible to implement the invention using a weight scale having only one force sensor, in which case clearly the parameter of pressure distribution across the force sensors is not determined.

The duration of the mounting period 34 is determined by calculating the time difference between the time stamp of the first measurement of the mounting period and the time stamp of the last measurement of the mounting period. The change in the duration of the mounting period from a historical duration value is determined by calculating the difference between the current mounting period duration and a previously determined mounting period duration. In some embodiments the previously determined mounting period duration is the most recent previously determined mounting period duration. In other embodiments the previously determined mounting period duration is the mounting period duration determined a predetermined amount of time prior to the determination of the current mounting period duration.

The duration of the balancing period 35a is determined by calculating the time difference between the time stamp of the last measurement of the balancing period and the time stamp of the last measurement of the mounting period. The last measurement of the balancing period is identified by the following process: local maxima and minima in the force signal 30 are detected. The amplitude difference between the maximum amplitude and the minimum amplitude for each adjacent local maximum-local minimum pair is calculated. When two or more consecutive max-min pairs have an amplitude difference less than a predefined threshold (i.e. the amplitude of the signal does not exceed a predefined range, such as the range 37 shown in FIG. 3), the measurement corresponding to the first peak of the first min-max pair is determined to be the last measurement of the balancing period. It will be appreciated that other known techniques could be used to identify the last measurement of the balancing period (such as, e.g., gradient methods, window based Standard Deviation (SD) in which the SD of each window is compared with a predefined threshold, etc.); however, the same technique should be used for each received plurality of force measurements. It will also be appreciated that alternative embodiments are possible in which different end points are used to determine the duration of the balancing period, for example in some embodiments the duration of the balancing period is determined by calculating the time difference between the time stamp of the last measurement of the balancing period and the time stamp of the first measurement of the balancing period. The change in the duration of the balancing period from a historical duration value is determined in the same manner as the change in the duration of the mounting period from a historical duration value.

The pressure distribution across the force sensors is determined by comparing the force measurements acquired by the different sensors.

The actual weight of the subject is determined by calculating the average measured force during the stable section 35b of the standing period 35. The change in actual weight from a historical weight value is determined by calculating the difference between the current actual weight value and a previously determined actual weight value. In some embodiments the previously determined actual weight value is the most recent previously determined actual weight value. In other embodiments the previously determined actual weight value is the actual weight value determined a predetermined amount of time prior to the determination of the current actual weight value.

In some embodiments, the degree of correlation between two or more of the determined parameters (e.g. the degree of correlation between change in actual weight and change in mounting period duration) is also calculated. In some such embodiments these correlations (hereafter referred to as “correlation parameters”) are treated as additional parameters for use in the calculation of the frailty index.

When the values of the one or more parameters relating to the mounting period and the one or more parameters relating to the standing period (and optionally the correlation parameters) have been determined, each of the determined parameter values (i.e. each of the determination results) is compared to a corresponding predefined threshold. The predefined thresholds are based on an historic database of frail patients. This database contains, for each patient, daily values for each of the parameters discussed above, as well as information about adverse events related to frailty such as falls, hospitalizations, ER visits and mortality and/or clinical frailty assessments made using the standard test. The adverse events and/or the clinical assessments are used to define a numerical scale of frailty against which the parameter values can be plotted to generate a relation between parameter value and degree of frailty for each individual parameter. In this way a “frailty score” is determined for each parameter. In preferred embodiments the numerical frailty scale runs from 0 (not frail) to 1 (too frail to self-measure weight). For each parameter a point on the numerical frailty scale is selected (based on the adverse event information and/or clinical assessments) as being indicative of a frail subject, and the threshold for that parameter is set as the parameter value corresponding to the selected point on the numerical frailty scale.

An overall frailty index is calculated based on the comparisons. If none of the parameter values exceeds its corresponding predefined threshold, then the patient is determined not to be frail, and the value of the overall frailty index is zero. If at least one of the parameter values exceeds its corresponding predefined threshold, the patient is determined to be frail and the overall frailty index will have a non-zero value. In preferred embodiments the frailty index ranges from 0 (not frail) to 1 (too frail to self-measure weight). It will be appreciated that the value of the frailty index (for a frail patient) can be calculated in different ways. For example, in some embodiments, the highest individual frailty score is taken as the overall frailty index. In other embodiments an average of two or more of the individual frailty scores is taken as the overall frailty index. In some embodiments the value of the overall frailty index is calculated based on the number of individual parameter values that exceed the corresponding thresholds.

In preferred embodiments historical parameter values for the subject are stored, e.g. by the control unit 6. In some such embodiments each newly determined parameter value is compared to the most recent historical value for that parameter. The progression over time of the parameters can thereby be tracked, and any value trends can be identified. In some embodiments historical values for the overall frailty index are stored, alternatively or additionally to historical values for the individual parameters. Hence the calculated frailty index can be used to track the progression of the patient over time. In some embodiments predefined rules are used to flag trends which could be clinically significant (e.g. if the value of the overall frailty index drops by 0.2 points or more within a month, an alert is sent to the subject's healthcare provider). This can trigger the healthcare provider to steer the subject's treatment in a particular direction or propose additional services or interventions.

In some embodiments the historical data is used to check the plausibility of newly determined parameter values. For example, if the difference between the newly determined parameter value and the most recent historical value for that parameter exceeds a predetermined threshold, the newly determined parameter value is discarded as implausible (and is therefore not taken into account in the calculation of the overall frailty index, or added to the historical data).

In some embodiments, one or more additional parameters are also considered in the calculation of the frailty index. These additional parameters can be, for example, a BMI of the subject and/or the grip strength of the subject. In embodiments in which a BMI of the subject is considered in the calculation of the frailty index the weight scale 4 and/or the control unit 6 is configured to receive height information about the subject. For example, in one such embodiment the weight scale 4 includes a keypad which allows a subject to input their height and is configured to send this height information to the control unit 6. In embodiments in which the grip strength of the subject is additionally considered in the calculation of the frailty index, the system 2 additionally includes a handgrip device for measuring the muscle strength of the patient. In some such embodiments the handgrip device is attached to the weight scale 4. Preferably the attachment is such that the patient cannot use the handgrip device for support when mounting the weight scale 4. In other embodiments the handgrip device is completely separate from weight scale 4. In preferred embodiments the handgrip device is configured to send grip strength measurements to the control unit 6.

A frailty index as provided for by embodiments of the present invention can beneficially be used to improve many aspects of health care. Areas for which a frailty index would be particularly beneficial include:

Physical activity programs and rehabilitation therapy. Subjects leaving hospital after a procedure are typically frailer than before the hospital stay due to loss in muscle strength. In these cases, physiotherapy and physical activity programs are often prescribed to improve a subject's functional status. However, the therapies are often managed remotely, based on a single initial assessment. By monitoring the frailty index in the manner described above, the therapy can be adjusted to match a subject's progress.

Selection of services for health or social care. As frailty directly impairs a subject's self-care ability, the frailty index can be used to recommend appropriate healthcare services for that subject.

Identification of health deterioration and the prevention of hospitalizations. By tracking frailty on a day-to-day basis, the deterioration of a subject can be detected. For example, if the frailty index drops below a predefined threshold, and/or the deterioration during a given period is larger than a predefined threshold, an alert may be raised to enable the healthcare professional to intervene at an early stage, possibly preventing a hospital admission.

Thus, in some embodiments the method includes the additional step 203 of proposing a course of action based on the calculated frailty index. In some such embodiments this involves comparing the calculated frailty index and/or any identified trends in the calculated frailty index and/or the values of the determined individual parameters to a database of possible actions. In some such embodiments the comparing is performed by the control unit 6. In some embodiments step 203 involves selecting one or more actions based on the comparing. In some such embodiments the selected action is communicated to the subject and/or their healthcare provider using any suitable communication technology.

There is therefore provided a method, apparatus and system that enable the measurement and monitoring of progression of frailty using a weight scale. Parameters derived from measurements acquired using the weight scale are combined into a numerical frailty index, the value of which can be tracked over time. This information provides the care giver with a better, broader and also more objective picture of the health condition of the subject. Quantified frailty progression information would be valuable for a number of applications. For example, it could be used to steer a physical activity or rehabilitation program, to select appropriate health and/or social care services for a subject, to identify health deterioration at an early stage and intervene accordingly, etc. Furthermore, as the weight scale is common device which is already used by many patients for remote monitoring purposes, the frailty measurement method, apparatus and system according to embodiments of the invention is suitable for use in a subject's home and can easily be integrated into their regular routine. It is therefore convenient and unobtrusive.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computer-implemented method for evaluating frailty of a subject, the method comprising the steps of:
receiving a plurality of force measurements obtained by a measurement apparatus configured to determine a weight of the subject standing on a user support surface of the measurement apparatus by measuring a force experienced by the user support surface; wherein the force measurements are obtained at regular time intervals over a measurement period during which the subject steps onto and subsequently stands on the user support surface;
calculating a frailty index indicative of a degree of frailty of the subject using the received force measurements;
wherein calculating the frailty index comprises the steps of:
(a) identifying a first section of the received force measurements within the measurement period as a mounting period, wherein the mounting period extends between a first time at which the subject first contacts the user support surface, and a second time at which entire weight of the subject becomes supported by the user support surface;
(b) identifying a second section of the received force measurements within the measurement period as a standing period, wherein the standing period commences after the end of the mounting period;
(c) determining one or more parameters relating to the mounting period;
(d) determining one or more parameters relating to the standing period;
(e) comparing each of the determined parameters to a corresponding predefined threshold; and
(f) calculating the frailty index based on the comparison; and,
generating an output signal indicative of the frailty index.

2. The computer-implemented method of claim 1, wherein the one or more parameters relating to the mounting period are selected from:
duration of the mounting period; and
change in duration of the mounting period from a historical duration value.

3. The computer-implemented method of claim 1, further comprising extracting an amplitude-versus-time signal from the received force measurements, wherein the standing period comprises a balancing section during which the amplitude variation of the extracted signal exceeds a predefined stability range, and a stable section during which the amplitude variation of the extracted signal is within the predefined stability range.

4. The computer-implemented method of claim 1, wherein the one or more parameters relating to the standing period are selected from a set of parameters comprising:
duration of the balancing period;
change in duration of the balancing period from a historical duration value;
actual weight of the subject; and
change in actual weight from a historical weight value.

5. The computer-implemented method of claim 4, wherein the received plurality of measurements comprises measurements obtained by a plurality of spatially separated force sensors, and wherein the set of parameters from which the one or more parameters relating to the standing period are selected from additionally includes:
pressure distribution across the plurality of force sensors.

6. The computer-implemented method of claim 1, further comprising:
receiving height information about the subject, and calculating the frailty index additionally comprises determining one or more parameters relating to a body mass index, BMI, of the subject; and/or
receiving one or more grip strength measurements, and calculating the frailty index additionally comprises determining one or more parameters relating to the grip strength of the subject.

7. The computer-implemented method of claim 1, wherein calculating the frailty index additionally comprises determining one or more correlation parameters, wherein a correlation parameter indicates a degree of correlation between two or more of the determined parameters relating to the mounting period and/or the determined parameters relating to the standing period.

8. The computer-implemented method of claim 1, wherein comparing each of the determined parameters to a corresponding predefined threshold comprises:
a) determining a frailty score for each one of the determined parameters by:
i) relating a determination result obtained in respect of the given determined parameter to a corresponding degree of frailty using a parameter-specific relation between the given determined parameter and degree of frailty, wherein the parameter-specific relation is generated based on historical frailty data for a group of patients; and
ii) calculating the frailty score based on the corresponding degree of frailty, and
b) comparing each determined frailty score to the corresponding predefined threshold; wherein the value of each of the corresponding predefined thresholds is set to correspond to a particular frailty score.

9. The computer-implemented method of claim 8, further comprising:
determining the subject to be not frail if none of the determined parameters exceeds the corresponding predefined threshold; or
determining the subject to be frail if one or more of the determined parameters exceeds the corresponding predefined threshold,

10. The computer-implemented method of claim 8, wherein calculating the frailty index comprises:
determining the frailty index to be a highest frailty score; or
determining the frailty index to be the average of two or more of the highest frailty scores.

11. The computer-implemented method of claim 10, further comprising:
storing at least each most recent historical determined parameter for the subject;
calculating, for each of the one or more parameters relating to the mounting period and the one or more parameters relating to the standing period, a difference between the current determined parameter and the most recent historical determined parameter; and
for each of the one or more parameters relating to the mounting period and the one or more parameters relating to the standing period, if the difference exceeds a predefined threshold, discarding the current determined parameter.

12. The computer-implemented method of claim 11, further comprising:
storing historical values of the frailty index for the subject; and
comparing a current frailty index value with the historical values to detect trends in the frailty index.

13. A computer program product, comprising computer readable code, the computer readable code being configured such that, on execution by a suitable computer or processor, the computer or processor performs at least:
receiving a plurality of force measurements obtained by a measurement apparatus configured to determine a weight of the subject standing on a user support surface of the measurement apparatus by measuring a force experienced by the user support surface; wherein the force measurements are obtained at regular time intervals over a measurement period during which the subject steps onto and subsequently stands on the user support surface;
calculating a frailty index indicative of a degree of frailty of the subject using the received force measurements;
wherein calculating the frailty index comprises the steps of:
(a) identifying a first section of the received force measurements within the measurement period as a mounting period, wherein the mounting period extends between a first time at which the subject first contacts the user support surface, and a second time at which entire weight of the subject becomes supported by the user support surface;
(b) identifying a second section of the received force measurements within the measurement period as a standing period, wherein the standing period commences after the end of the mounting period;
(c) determining one or more parameters relating to the mounting period;
(d) determining one or more parameters relating to the standing period;
(e) comparing each of the determined parameters to a corresponding predefined threshold; and
(f) calculating the frailty index based on the comparison; and,
generating an output signal indicative of the frailty index.

14. Apparatus for use in assessing the frailty of a subject, comprising a control unit configured to perform the computer-implemented method of claim 1.

15. System for use in assessing the frailty of a subject, comprising:
a measurement unit coupled to a user support surface configured to be stepped onto and subsequently stood on by the subject, wherein the measurement unit is configured to measure a force applied to the user support surface at regular time intervals over a measurement period during which the subject steps onto and subsequently stands on the user support surface; and
an apparatus according to claim 14.
